(19) United States
(12) Patent Application Publication
(10) Pub. No.: US 2019/0063524 A1
(43) Pub. Date: Feb. 28, 2019

(54) MOTOR VEHICLE BRAKE ROTOR SPEED REDUCTION MECHANISM

(71) Applicant: Benjamin V. Booher, Scottsdale, AZ (US)

(72) Inventor: Benjamin V. Booher, Scottsdale, AZ (US)

(21) Appl. No.: 16/113,780

(22) Filed: Aug. 27, 2018

Related U.S. Application Data
(60) Provisional application No. 62/550,287, filed on Aug. 25, 2017.

(51) Int. Cl. F16D 65/12; F16D 65/847; B60B 27/00

(52) U.S. Cl. CPC F16D 65/123; F16D 65/847; F16D 2065/1392; B60B 27/0052; F16D 65/128

(57) ABSTRACT

A brake rotor speed reduction system is disclosed. The system includes a brake rotor having a rotor body and a ring gear of a planetary gear system. The system also includes a central axle, and a wheel plate coupled to a hub bearing, the hub bearing coupled to the axle and including a solar gear of the planetary gear system. The system also includes a plurality of planet gears, each planet gear rotatably coupled to a different gear shaft of a plurality of gear shafts and engaged with both the ring and solar gears. Rotation of the solar gear in a first direction drives the rotation of each planet gear about the gear shaft to which it is coupled in a second direction, in turn driving the ring gear to rotate in the first direction and causing the brake rotor to rotate slower than the wheel plate.

### RELATED APPLICATIONS

This application claims the benefit of U.S. provisional patent application 62/550,287, filed Aug. 25, 2017 titled “Motor Vehicle Brake Rotor Speed Reduction Mechanism,” as well as U.S. provisional patent application 62/556,668, filed Sep. 11, 2017 titled “Motor Vehicle Brake Rotor Speed Reduction Mechanism”. The entirety of the above referenced disclosures are hereby incorporated herein by this reference.

### TECHNICAL FIELD

Aspects of this document relate generally to brake rotor speed reduction mechanisms.

### BACKGROUND

Disc brakes are a common method for reducing the speed of wheeled vehicles. The brake rotor (or disc) is the rotating part of a motor vehicle disc brake assembly against which brake pads are applied to create the braking force needed to slow and stop a vehicle. Brake rotors can be subjected to rather extreme service conditions throughout various use cycles common to motor vehicle operation, including exposure to high speeds and harsh or inclement environmental conditions. A vehicle traveling at high speed requires heavy braking in order to slow down. As a consequence, the increased heat generated by the friction of braking causes rotor wear, and may also include warping and scoring. Repeated application of heavy braking can also cause brake fade, a dangerous condition resulting in diminished brake performance. Furthermore, in certain weather conditions, or in the case of high water on roadways, water can act as a lubricant, diminishing the effectiveness of the interaction between the rotors and pads and causing brake fade. In such cases, the frictional force applied to the pads as they engage the rotor is insufficient to overcome the rotational velocity of the rotor. More effective forms of braking often come at the cost of durability, wearing out the brake rotor hardware quickly, which presents a different set of safety concerns, along with increased cost.

### SUMMARY

According to one aspect, a brake rotor speed reduction system may comprise a brake rotor having a rotor body comprising a ring gear of a planetary gear system, a central axle, a wheel plate coupled to a hub bearing comprising a solar gear of the planetary gear system, the hub bearing coupled to the axle, a plurality of planet gears, each planet gear rotatably coupled to a different gear shaft of a plurality of gear shafts and engaged with both the ring gear and the solar gear, wherein rotation of the solar gear coupled to the wheel plate in a first direction drives the rotation of each planet gear about the gear shaft to which it is coupled in a second direction opposite the first direction which in turn drives the ring gear of the rotor body to rotate in the first direction and drives the brake rotor to rotate slower than the wheel plate.

Particular embodiments may comprise one or more of the following features. An upright assembly, wherein the axle and the plurality of gear shafts are fixedly coupled to the upright assembly. The plurality of gear shafts may extend outward from a faceplate of the upright assembly, the plurality of gear shafts and central axle all substantially parallel and extending in the same direction. The relative position of each gear shaft with respect to the axle may be fixed. The plurality of gear shafts may be fixedly coupled to each other through a gear yoke that holds the position of each gear shaft with respect to the plurality of gear shafts fixed as the gear shafts rotate about the axle. The hub bearing may be rotatably coupled to the axle. The planetary gear system may be contained within an encasement comprising an outer seal bearing coupled to the hub bearing, the rotor body coupled to an inner bearing plate, and the inner bearing plate coupled to an inner sealing plate. At least one of the solar gear and each of the plurality of planet gears may be held in alignment within the planetary gear system by at least one positioning bearing.

According to an aspect, a brake rotor speed reduction system may comprise a brake rotor having a rotor body comprising a ring gear of a planetary gear system, a central axle, a wheel plate coupled to a hub bearing comprising a solar gear of the planetary gear system, the hub bearing fixedly coupled to the axle, and a plurality of planet gears, each planet gear rotatably coupled to a different gear shaft of a plurality of gear shafts and engaged with both the ring gear and the solar gear, wherein the plurality of gear shafts are fixedly coupled to each other through a gear yoke that holds the position of each gear shaft with respect to the plurality of gear shafts fixed as the gear shafts rotate about the axle, and wherein rotation of the solar gear coupled to the wheel plate in a first direction drives the rotation of each planet gear about the gear shaft to which it is coupled in a second direction opposite the first direction which in turn drives the ring gear of the rotor body to rotate in the first direction and drives the brake rotor to rotate slower than the wheel plate.

Particular embodiments may comprise one or more of the following features. The planetary gear system may be contained within an encasement comprising an outer seal bearing coupled to the hub bearing, the rotor body coupled to an inner bearing plate, and the inner bearing plate coupled to an inner sealing plate. The plurality of planet gears may comprise two planet gears positioned opposite each other with the axle in between. The brake rotor may further comprise a floating rotor facing portion coupled to the periphery of the rotor body. The planetary gear system may be coplanar with the brake rotor body. The brake rotor may be slotted. The brake rotor may be ventilated.

According to an aspect, a brake rotor speed reduction system may comprise a brake rotor having a rotor body comprising a ring gear of a planetary gear system, an upright assembly comprising a central axle and a plurality of gear shafts extending outward from a faceplate, the plurality of gear shafts and central axle all substantially parallel and extending in the same direction, a wheel plate coupled to a hub bearing comprising a solar gear of the planetary gear system, the hub bearing rotatably coupled to the axle, and a plurality of planet gears, each planet gear rotatably coupled to a different gear shaft of a plurality of gear shafts and engaged with both the ring gear and the solar gear, wherein rotation of the solar gear coupled to the wheel plate in a first direction drives the rotation of each planet gear about the gear shaft to which it is coupled in a second direction opposite the first direction which in turn drives the ring gear of the rotor body to rotate in the first direction and drives the brake rotor to rotate slower than the wheel plate.

Particular embodiments may comprise one or more of the following features. The planetary gear system may be contained within an encasement comprising an outer seal bearing coupled to the hub bearing, the rotor body coupled to an inner bearing plate, and the inner bearing plate coupled to an inner sealing plate. The plurality of planet gears may comprise two planet gears positioned opposite each other with the axle in between. The brake rotor may further comprise a floating rotor facing portion coupled to the periphery of the rotor body. The brake rotor is at least one of slotted and ventilated.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The invention will hereinafter be described in conjunction with the appended drawings, where like designations denote like elements, and:

FIGS. 1A and 1B are representative exploded and assembled side views of a conventional disc brake assembly;

FIGS. 2A and 2B are representative exploded and assembled cutaway side views of a brake rotor speed reduction system;

FIG. 2C is a front view of the a representative brake rotor speed reduction system of FIG. 2A;

FIG. 3A is a side cutaway view of a representative brake rotor speed reduction system;

FIG. 3B is a front view of the representative brake rotor speed reduction system of FIG. 3A;

FIG. 4A is a perspective cutaway view of a representative brake rotor speed reduction system;

FIG. 4B is a side cutaway view of the representative brake rotor speed reduction system of FIG. 4A; and

FIG. 4C is a front view of the representative brake rotor speed reduction system of FIG. 4A.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Disc brakes are a common method for reducing the speed of wheeled vehicles. The brake rotor (or disc) of a disc brake assembly is the rotating part against which brake pads are applied to create the braking force needed to slow and stop a vehicle. Brake rotors may employ a variety of designs, often depending on the weight, power, and/or part (e.g. front end, back end) of the vehicle where they will be used.

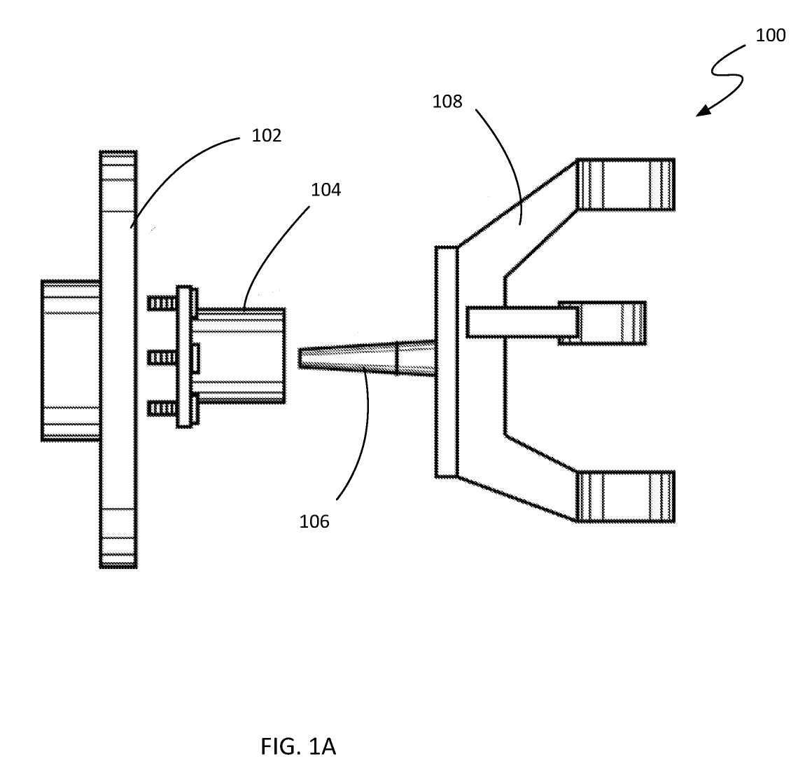

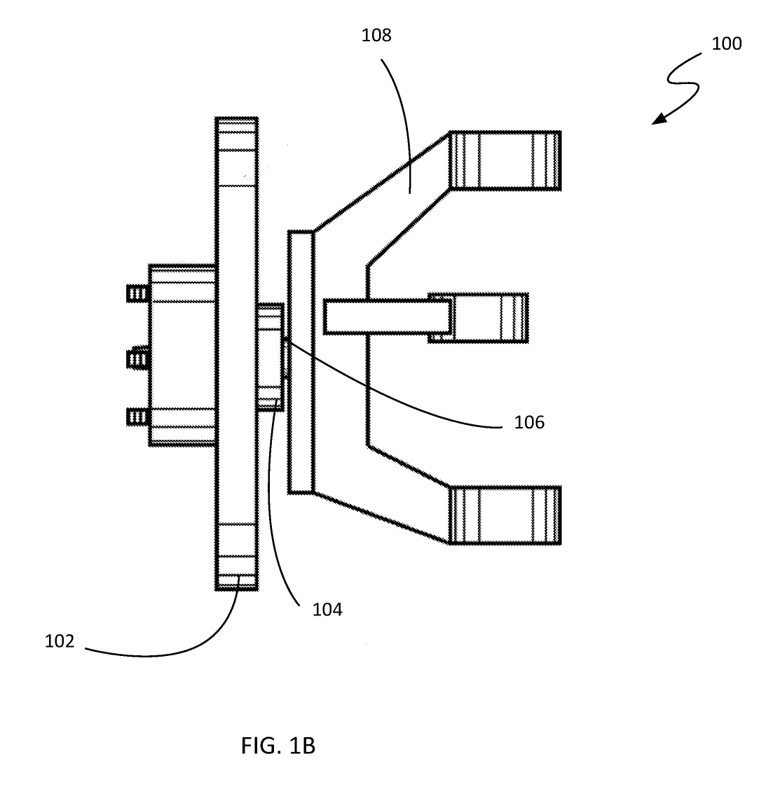

FIGS. 1A and 1B show a representative conventional disc brake assembly 100. Specifically, FIG. 1A is an exploded side view, and FIG. 1B is an assembled side view. As shown, a conventional disc brake assembly 100 may comprise a brake rotor 102, a hub assembly 104, a central axle 106, and an upright assembly 108. As shown, the brake rotor 102 fits over the hub assembly 104 which is rotatably coupled to the central axle 106 which is fit to the upright assembly 108. The upright assembly 108 provides the structure for attaching the brake assembly to the vehicle. The wheel (not shown) is fixedly coupled to the hub assembly 104. The wheel, chassis, engine and other parts of a car, truck or other vehicle are known in the art and the structure and operation of such are incorporated herein by this reference. An example of vehicle components may be found in U.S. Pat. No. 5,388,658, issued Feb. 14, 1995, U.S. Pat. No. 5,878,357, issued Mar. 2, 1999, and U.S. Pat. No. 5,927,832, the disclosures of each of which are incorporated herein by this reference for their recitation of conventional automobile components.

Some brake rotors may be solid and whole, while others may include one or more openings, such as fins or vanes that join together the brake rotors' two outer contact surfaces (i.e. the surface in contact with the brake pads during braking). These openings are usually created as part of a casting process, or may be machined. The ventilated rotor design may help to dissipate heat, and is commonly used on the more heavily loaded front rotors, while many rear rotors are solid.

Another typical brake rotor design is slotted. Slotted rotors have shallow channels machined into the disc to aid in removing dust and gas. Slotting is a common method in most racing environments to remove gas and moisture, as well as to deglaze the brake pads. Some brake discs may be both ventilated and slotted. Slotted discs are not commonly used on standard (i.e. non-racing) vehicles because they more quickly wear down brake pads. Such removal of material is beneficial to race vehicles, since it keeps the pads soft and avoids vitrification (or glazing) of their surfaces. However, standard vehicles may also benefit from drilled or slotted discs, particularly in wet conditions because the holes or slots prevent a film of water from building up between the disc and the pads.

Brake rotors can be subjected to rather extreme service conditions throughout various use cycles common to motor vehicle operation, including exposure to high speeds and harsh or inclement environmental conditions. A vehicle traveling at high speed requires heavy braking in order to slow down. As a consequence, the increased heat generated by the friction of braking causes rotor wear, and may also include warping and/or scoring of the brake rotor. Repeated application of heavy braking can also cause brake fade, a dangerous condition resulting in diminished brake performance. Furthermore, in certain weather conditions, such as in the case of high water on roadways, water can act as a lubricant, diminishing the effectiveness of the interaction between the rotors and pads and causing brake fade. In such cases, the frictional force applied to the pads as they engage the rotor may be insufficient to overcome the rotational velocity/force of the rotor. Such an effect may be greatly compounded by vehicle speed, which relates directly to the rotational speed of the rotor.

Although slotting and/or ventilating brake rotors can result in improved braking power, the increased effectiveness comes at a price. The holes and slots may cause increased friction, and therefore heat, and may also wear down brake pads faster than solid brake rotors. The benefits of these rotor designs must be balanced against their impact on the lifespan of various parts of the brake assembly. Rotor wear is a major concern for manufactures, and can have detrimental effects on brake performance. Rotor wear can be traced to many hundreds of millions of dollars in brake system warranty loses suffered each year by original equipment automobile (OEM) manufacturers. In general, the more aggressively the brakes are used, the more extreme the rotor wear becomes, and the faster the vehicle travels the faster the rotor rotates, which compounds all such ill-effects. Therefore, regardless of the rotor design, elevated speed and ‘sliding time’ (i.e. the amount of time the rotor and pads come together to brake the vehicle) can produce enough heat to accelerate rotor and pad wear, compromising vehicle performance.

Among other things, embodiments of the present disclosure provide a mechanism by which the rotational speed of the brake rotor, with respect to the rotational speed of a motor vehicle wheel and tire assembly, is reduced, resulting in improved brake effectiveness and performance while reducing wear to brake linings and rotors. Such a reduction in rotational speed may also allow for a reduction in the size and weight of brake components and assemblies. Additionally, a reduction in the rotational speed of the brake rotor with respect to the speed of the tire assembly may permit the use of slotted and/or ventilated brake rotors, reaping their benefits while reducing the accompanying reduction in lifespan.

Contemplated herein are various embodiments of a brake assembly comprising a brake rotor speed reduction mechanism. Specifically, the rotor speed reduction mechanism reduces the rotational speed of the brake rotor with respect to the rotational speed of the associated vehicle wheel and tire assembly. According to various embodiments, the mechanism makes use of one or more gears to create a rotational speed differential. This difference in rotational speed between the brake rotor and the wheel reduces the brake force necessary to slow and stop the vehicle. In some embodiments, this reduction of required brake force may result in a more effective braking system. In other embodiments, this increased performance may provide the option of reducing the size and weight of brake components, reducing rotor wear and related OEM warranty losses without sacrificing safety.

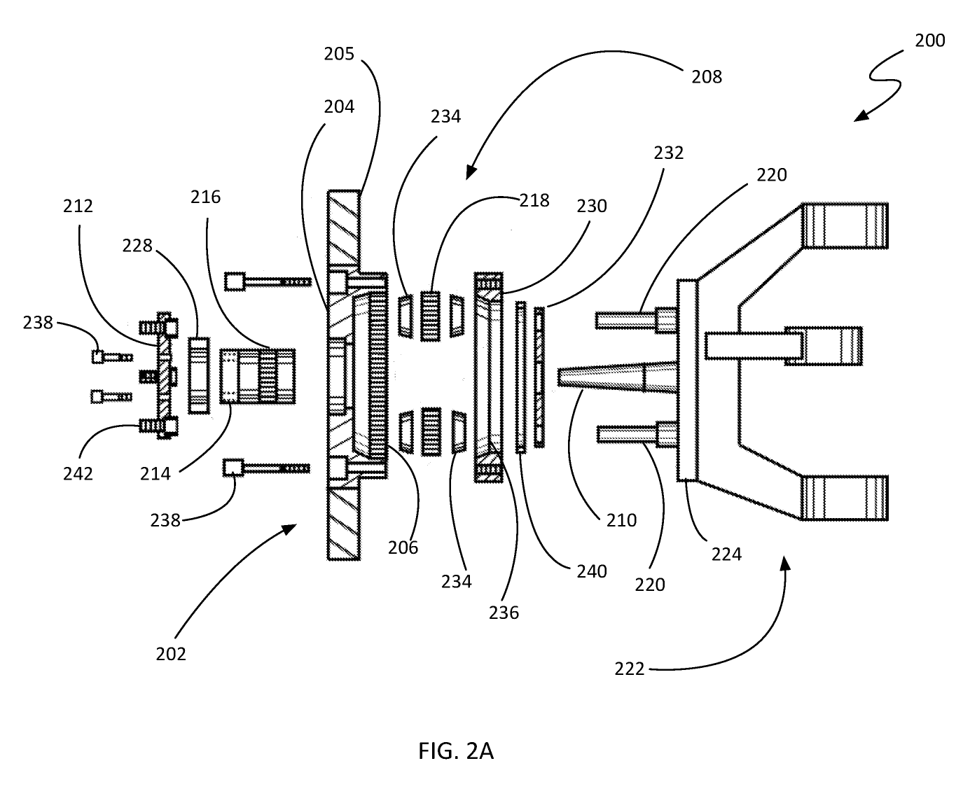

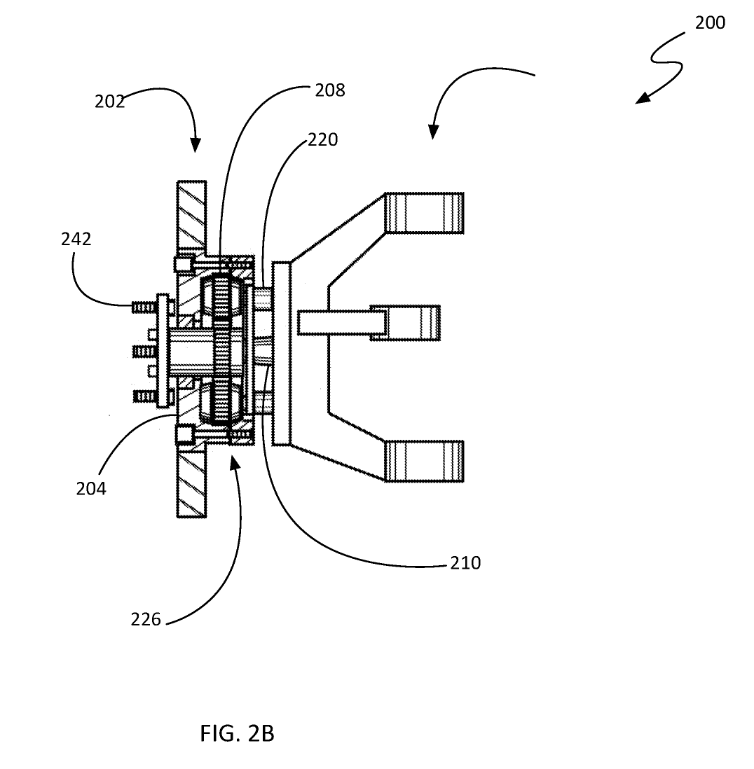

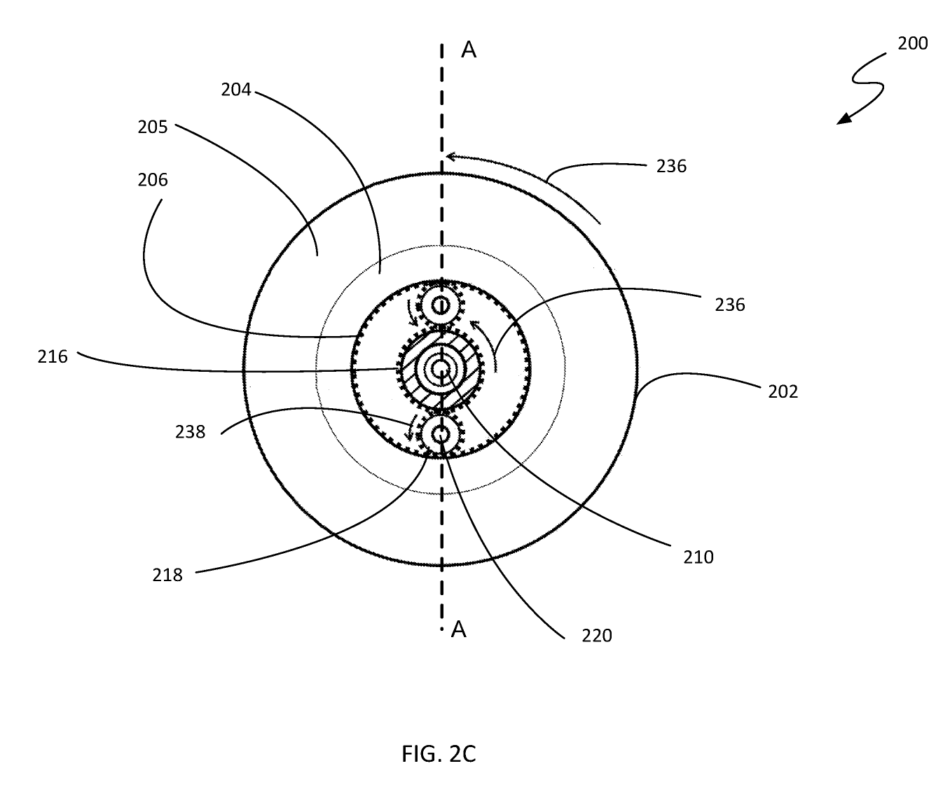

FIGS. 2A, 2B, and 2C show various views of a non-limiting example of a brake rotor speed reduction system 200 configured to reduce the rotational speed of the brake rotor in relation to the rotational speed of a motor vehicle wheel and tire assembly. Specifically, FIGS. 2A and 2B show exploded and assembled cutaway side views of a brake rotor speed reduction system 200. FIG. 2C shows a front view of the same (i.e. viewed along the axle). For clarity, in FIGS. 2A and 2B, the wheel plate 212, brake rotor 202, and inner bearing plate 230 are depicted as cut away along line A-A of FIG. 2C.

As shown, the brake rotor speed reduction system 200 comprises a brake rotor 200 and a hub bearing 214. The brake rotor 202 may comprise a rotor body 204, a facing 205 (i.e. the portion of the brake rotor 202 that makes contact with the brake pads). The hub bearing 214 may be coupled to a wheel plate 212 in any manner known in the art, including bolted on using machine screws 238. The wheel plate 212 presents a plurality of studs 242 for mounting a vehicles wheel, as is known in the art. In some embodiments, the system 200 may also comprise an upright assembly 222 having a central axle 210 about whose axis the wheel and brake rotor 202 rotate.

Additionally, the brake rotor speed reduction system 200 comprises a planetary gear system 208 through which the reduction of rotation speed is accomplished. According to various embodiments, the planetary gear system 208 comprises a ring gear 206, a solar gear 216, and a plurality of planet gears 218. According to various embodiments, the ring gear 206 may be coupled to or integral with the brake rotor 202. For example, as shown in FIGS. 2A and 2B, the ring gear 206 may be incorporated into the rotor body 204. The solar gear 216 may be coupled to or integral with the hub bearing 214. The plurality of planet gears 218 are each engaged with both the solar gear 216 and the ring gear 206. The operation of a planetary gear system 208 will be discussed in greater detail below with respect to FIG. 2C.

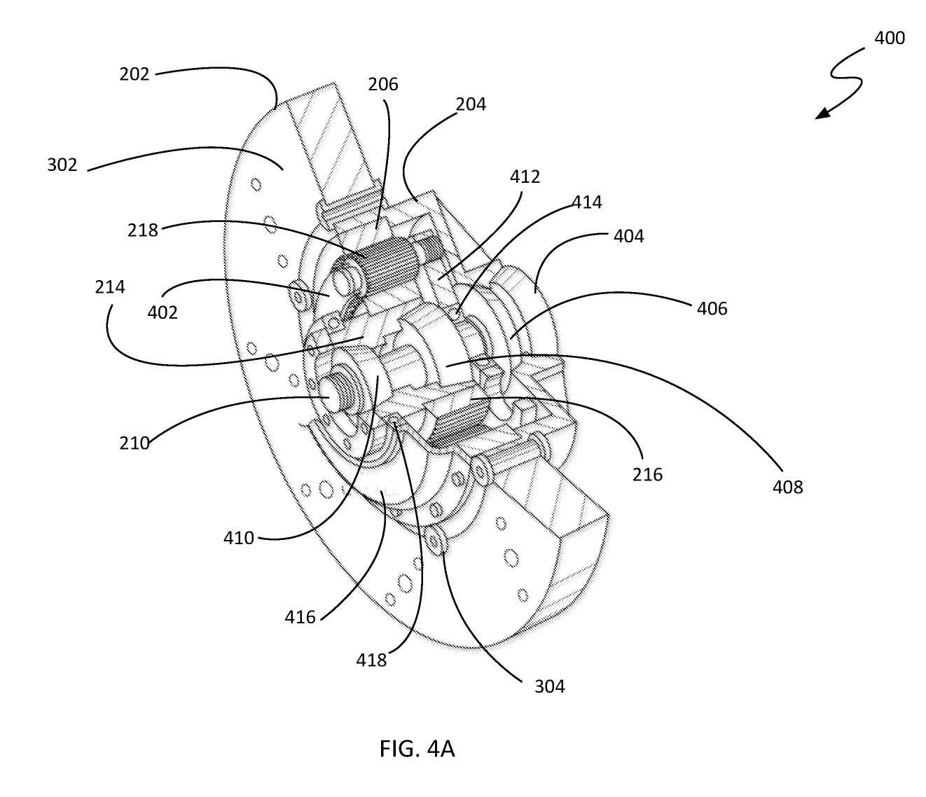

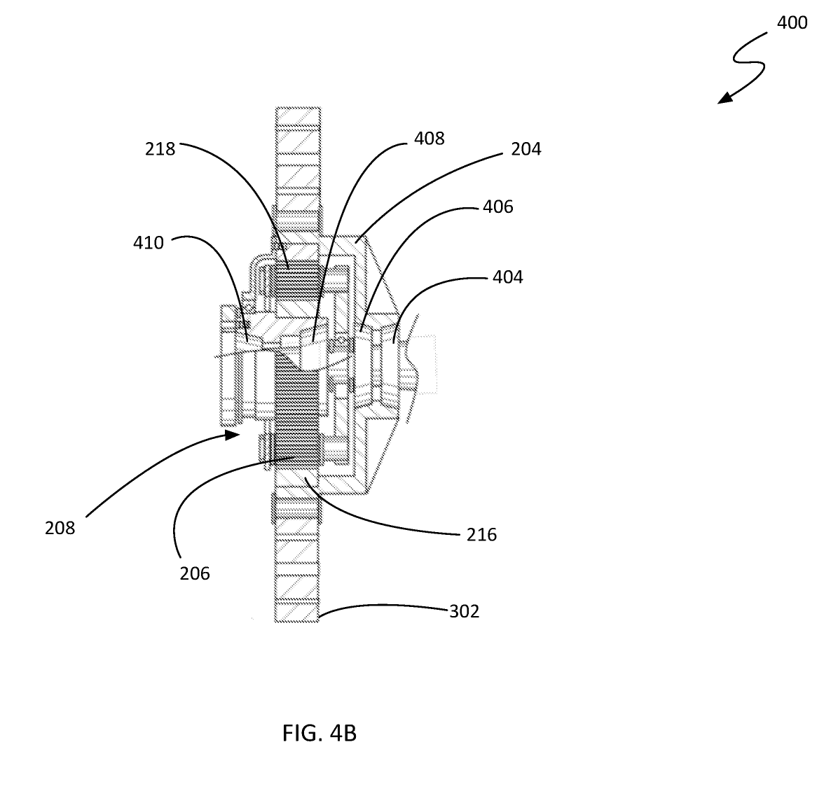

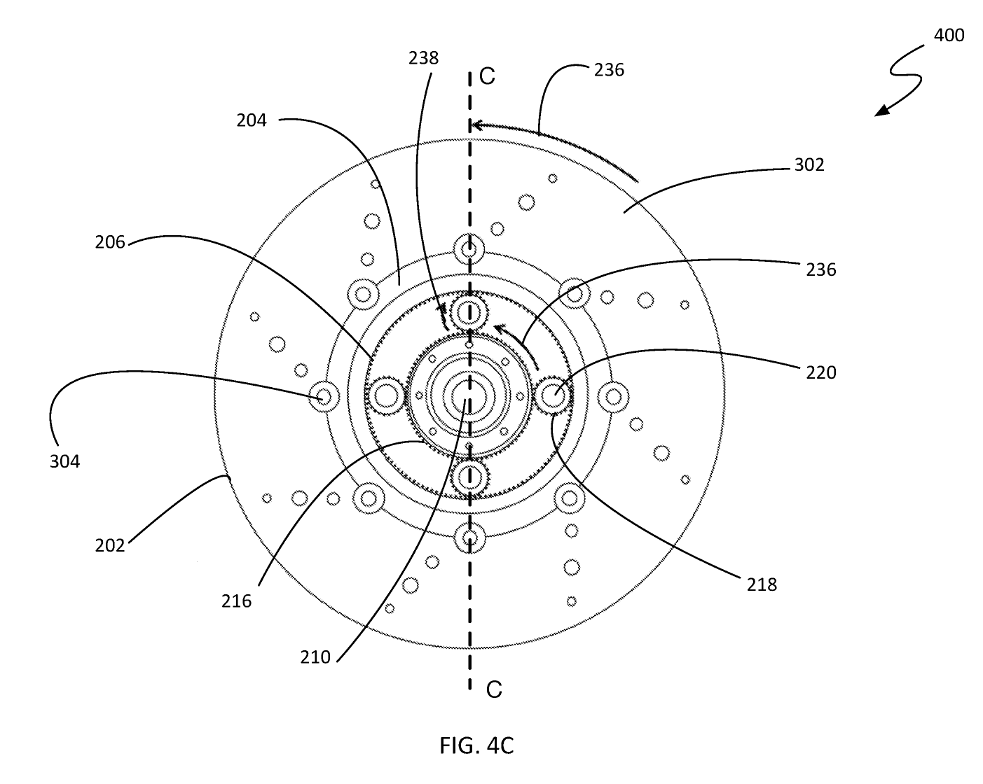

The non-limiting example shown in FIGS. 2A-2C includes an upright assembly 222 having a plurality of gear shafts 220 on which the planet gears 220 rotate. According to various embodiments, the upright assembly 222 may comprise a faceplate 224 from which the plurality of gear shafts 220 extend. In some embodiments, the gear shafts 220 are affixed to the faceplate 224, while in others the gear shafts 220 are integral with the faceplate 224. These gear shafts extend in the same direction as the central axle 210. According to various embodiments, each of the gear shafts 220 is substantially parallel to the central axle 210. In the context of the present description and the claims that follow, substantially parallel means parallel to within 10 degrees. In other embodiments, a brake rotor speed reduction system may be adapted for use with conventional upright assemblies that may lack gear shafts 220 for the planet gears 218. These embodiments will be discussed in greater detail below with respect to FIGS. 4A, 4B, and 4C.

According to various embodiments, the planetary gear system 208 may further comprise one or more bearings coupled to the various gears. For example, in some embodiments, the solar gear 216, the planet gears 218, or both, may be held in alignment within the planetary gear system 208 by at least one positioning bearing 234. As a specific example, in one embodiment, the planet gears 218 may each be coupled to a positioning bearing 234 that rubs against the inner bearing plate bearing face 236 for a stable, aligned rotation about the solar gear 216. Furthermore, a ring bearing 240 may be used to facilitate the rotation of the ring gear 206 and the brake rotor 202 to which it is coupled.

The ease with which the gears of the planetary gear system 208 may move with respect to each other may have a large impact on the lifespan and efficiency of the brake rotor speed reduction system 200. According to various embodiments, the gears of the planetary gear system 208 may be protected within an encasement 226. In some embodiments, the encasement 226 may be formed from an outer seal bearing 228 coupled to the hub bearing 214, in combination with the rotor body 204 which may be bolted or otherwise coupled to an inner bearing plate 230, and finally may include an inner sealing plate 232. According to various embodiments, the outer seal bearing 228 and inner sealing plate 232 are utilized to protect the inner components of the encasement 226 which includes the solar gear 216 of the hub bearing 214, which drives the ring gear 206 by way of interaction with the planet gears 218. The hub bearing 214 passes through the encasement 226 while the gears remain protected.

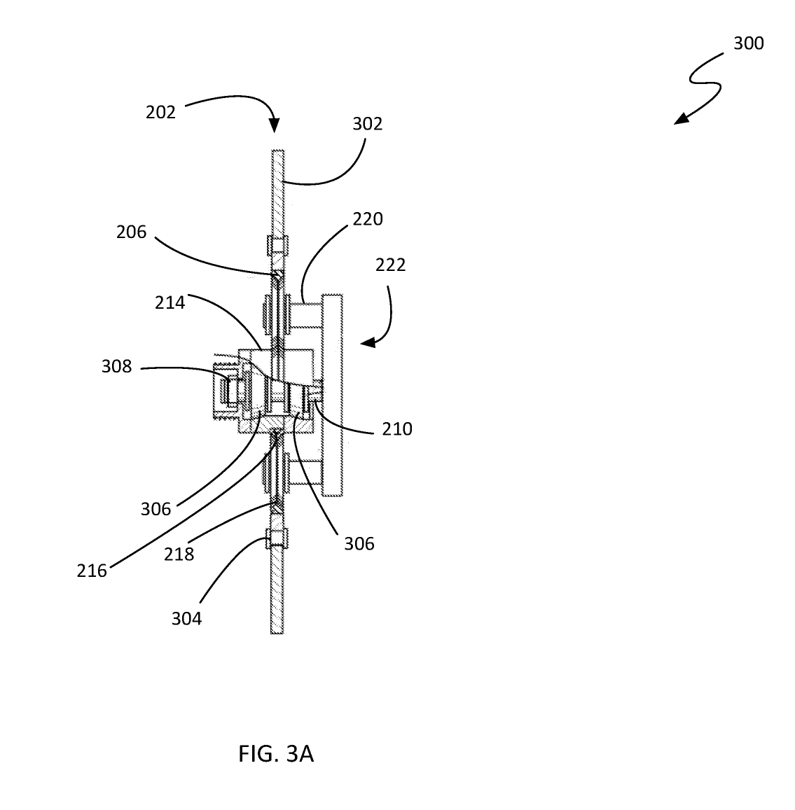

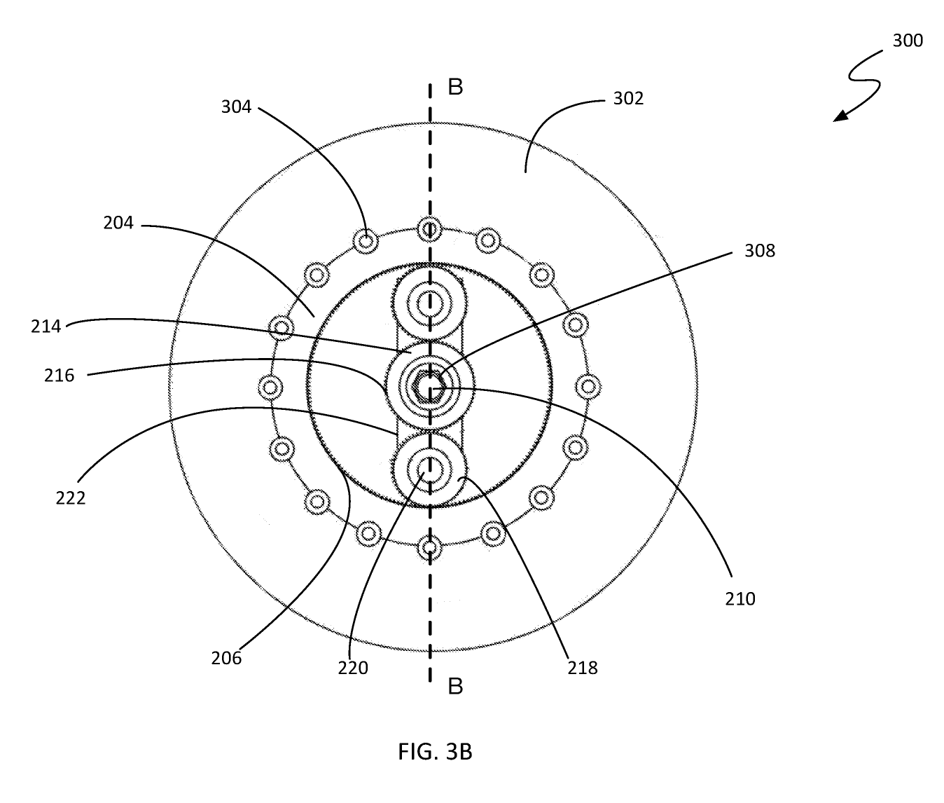

As seen in FIG. 2B, the planetary gear system 208 is contained within, and is coplanar with, the brake rotor body 204. In some embodiments, the planetary gear system 208 may be coplanar with the brake rotor body 204. In the context of the present description and the claims that follow, to be coplanar with the brake rotor body 204 means that the planes of rotation of the individual components of the planetary gear system 208 are each substantially coplanar with the plane of rotation of the rotor body 204, while in operation, and that the planetary gear system 208 is entirely within the rotor body 204. Substantially coplanar means coplanar within 15 degrees. Such a configuration allows for implementing the brake rotor speed reduction system 200 in a compact brake apparatus. See, for example, FIGS. 3A and 3B.

In the non-limiting example shown in FIGS. 2A and 2B, the hub bearing 214 is rotatably coupled to the axle 210 while the gear shafts 220 are fixed in their position with respect to the axle 210. In other embodiments, the hub bearing 214 may be fixedly coupled to the axle 210, and the gear shafts 220 are allowed to orbit the axis of the axle 210. Such an implementation will be discussed in greater detail with respect to FIGS. 4A-4C.

FIG. 2C is a front view (e.g. looking along the axle) of a non-limiting example of a brake rotor speed reduction system 200. Various parts have been removed (e.g. wheel plate 212, outer seal bearing 228, etc.) and other parts have been cut away (e.g. the face of rotor body 204) to more clearly show how the planetary gear system 208 is implemented.

A planetary gear system (also called an epicyclic gear system) is made up of two gears arranged such that the center of one gear (a planet gear) is able to revolve around or orbit the center of the other gear (the solar gear). A carrier gear connects the centers of these two gears, and a ring gear that encompasses the planet and solar gears rotates to carry the planet gear around the solar gear. Such systems may make use of more than one planet gear. Depending on what is held fixed and which gear is driven, a planetary gear system may be used to increase or decrease rotational speed, and even reverse its direction.

In the non-limiting example of the brake rotor speed reduction system 200 shown in FIGS. 2A-2C, the carrier is the upright assembly 222, which provides a central axle 210 on which the hub bearing 214 spins and a plurality of gear shafts 220 on which planet gears 218 spin. Referring now to FIG. 2C, driving the solar gear 216 in a first direction 236 (e.g. rotating a vehicle's wheel) drives the rotation of the planet gears 218 on their gear shafts 220 in a second direction 238 opposite the first direction 236, which in turn drives the ring gear 206 in the first direction 236 at a slower rate than the solar gear 216. This results in the brake rotor 202 (which comprises the ring gear 206) being driven to rotate at a slower speed than the wheel plate 212 (which is coupled to the hub bearing 214) is being driven. Such a reduction may be sufficient enough to allow for the use of smaller brake components and/or increase performance, as previously discussed. The non-limiting example shown in FIG. 2C comprises two planet gears 218. In other embodiments, additional planet gears 218 may be employed.

FIGS. 3A and 3B show various views of a non-limiting example of a brake rotor speed reduction system 300 designed to be compact and lightweight. Specifically, FIG. 3A shows a side cutaway view, with portions (including the brake rotor 202) being cut along line B-B of FIG. 3B, and other elements, such as the hub bearing 214, being partially cut away, for clarity. FIG. 3B shows a front (e.g. axle facing) view, with obscuring elements (e.g. front face of rotor body 204, front end of hub bearing 214, etc.) removed to better illustrate the interaction of the planet gears 218 with the solar gear 216.

As shown, the rotor body 204, joined to a floating rotor facing portion 302 by trapping hardware 304, incorporates at its inner most portion a ring gear 206, which is driven by counter rotating planet gears 218 rotationally fit on gear shafts 220 fixed to an upright assembly 222. As an option, the planet gears 218 may be split “V” type gears.

As previously discussed, the planet gears 218 are set in motion by the solar gear 216 of the hub bearing 214 which revolves around the central axle 210 of the upright assembly 222. According to various embodiments, the solar gear 216 may be held in rotational position by taper bearings 306, and the assembly may be secured in place by a locking nut 308.

In some embodiments, a floating rotor facing 302 may be splined with, rather than rigidly affixed to, the rotor body 204 as a way of avoiding thermal stress, cracking and warping. This may allow the disc to expand in a controlled symmetrical way and with less unwanted heat transfer to the hub. This arrangement also allows self-centering of the rotor respective of its pathway through the caliper, so as to reduce drag forces induced by the rotor to the lining contact, otherwise resulting from the imprecise function of common brake systems that may not fully retract the inner and outer lining. Such an arrangement is also beneficial in motorcycle applications which ordinarily utilize rotors that are thinner and more susceptible to rotor and lining irregularities. Those of ordinary skill in the art will readily be able to apply the principles disclosed herein to a motorcycle brake configuration from the disclosure provided herein.

According to various embodiments, the brake rotors 202 contemplated herein may be composed of grey iron, a form of cast iron. In other embodiments, the brake rotors 202 may be made of more exotic materials, including but not limited to aluminum alloys, carbon, ceramic, and other materials and composites known in the art.

Embodiments of the brake rotor speed reduction system contemplated herein may be adapted to free wheel and drive-wheel axle assemblies, and may incorporate any rotor type (e.g. solid, slotted, ventilated, floating, etc.) and material.

The embodiments previously discussed employed a planetary gear system 208 whose planet gears 218 were held in a fixed position with respect to the central axle 210. This was accomplished by fitting them to rotate on gear shafts 220 that extending out from the upright assembly 222 that also comprises the central axle 210. In other embodiments, a brake rotor speed reduction system 400 may be adapted for use with conventional upright assemblies (e.g. mounted to a single axle) that do not comprise gear shafts 220 for planet gears 218. Said systems may be retrofit to existing vehicles with minimal modifications, while still providing high performance in a compact design.

FIGS. 4A-4C show various views of a non-limiting example of a brake rotor speed reduction system 400 configured for use with a single axle. Specifically, FIG. 4A shows a perspective cutaway view of a brake rotor speed reduction system 400, with segments of the brake rotor 202 and neighboring structures removed to illustrate the inner workings of the planetary gear system 208. FIG. 4B is a side cutaway view, with portions (including the brake rotor 202) being cut along line C-C of FIG. 4C, and other elements, such as the hub bearing 214, being partially cut away, for clarity. FIG. 4C shows a front (e.g. axle facing) view, with obscuring elements (e.g. front face of rotor body 204, front end of hub bearing 214, etc.) removed to better illustrate the interaction of the planet gears 218 with the solar gear 216.

According to various embodiments, the brake rotor 202 may be integral or fit to the rotor body 204 having a ring gear 206. The ring gear 206 may be coupled to an outer rotor bearing 404 and an inner rotor bearing 406. As shown, the hub bearing 214 comprises an inner hub bearing 408 and an outer hub bearing 410, in addition to a solar gear 216. Both the hub and rotor bearing assemblies ride on a central axle 210. A planetary gear hub 412, comprising a plurality of gear shafts 220 also affixed to a gear yoke 402, also rides on the central axle 210 by way of a gear hub bearing 414.

As shown, each gear shaft 220 has a planet gear 218 between the planetary gear hub 412 and the gear yoke 402, engaged with the solar gear 216 and the ring gear 206. Unlike the embodiments previously discussed, here the position of the planet gears 218 with respect to the central axle 210 is not held fixed, but rather is allowed to orbit, removing the need for a special upright assembly 222. In some embodiments, it is the hub bearing 214 that is held fixed.

According to various embodiments, the internal workings of the planetary gear system in its entirety are closed to environmental elements by a front cover 416 coupled to a front seal bearing 418. In some embodiments configured for high performance applications, the rotor facing 302 may be fit to the rotor body 204 by trapping hardware 304 which can be engineered to allow a desirable amount of rotor float to enhance rotor centering within the caliper.

In operation, as the wheels of the vehicle turn, the solar gear 216 engages the planet gears 218 which in turn engage the ring gear 206, effecting a reduction in the rotational speed of the brake rotor 202 compared to the rotational speed of the tire and wheel assembly. Such a reduction may provide a number of performance and safety advantages over conventional systems including, but not limited to, increased braking capability, reduced heat, reduced rotor and pad wear, and increased fade resistance.

It will be understood that implementations are not limited to the specific components disclosed herein, as virtually any components consistent with the intended operation of a method and/or system implementation for a motor vehicle brake rotor speed reduction mechanism may be utilized. Accordingly, for example, although particular brake rotor speed reduction mechanisms may be disclosed, such components may comprise any shape, size, style, type, model, version, class, grade, measurement, concentration, material, weight, quantity, and/or the like consistent with the intended operation of a method and/or system implementation for a motor vehicle brake rotor speed reduction mechanism may be used. In places where the description above refers to particular implementations of brake rotor speed reduction mechanisms, it should be readily apparent that a number of modifications may be made without departing from the spirit thereof and that these implementations may be applied to other brake rotor speed reduction mechanisms.

What is claimed is:

1. A brake rotor speed reduction system, comprising:
a brake rotor having a rotor body comprising a ring gear of a planetary gear system;
a central axle;
a wheel plate coupled to a hub bearing comprising a solar gear of the planetary gear system, the hub bearing coupled to the axle; and
a plurality of planet gears, each planet gear rotatably coupled to a different gear shaft of a plurality of gear shafts and engaged with both the ring gear and the solar gear;
wherein rotation of the solar gear coupled to the wheel plate in a first direction drives the rotation of each planet gear about the gear shaft to which it is coupled in a second direction opposite the first direction which in turn drives the ring gear of the rotor body to rotate in the first direction and drives the brake rotor to rotate slower than the wheel plate.

2. The brake rotor speed reduction system of claim 1, further comprising an upright assembly, wherein the axle and the plurality of gear shafts are fixedly coupled to the upright assembly.

3. The brake rotor speed reduction system of claim 2, wherein the plurality of gear shafts extend outward from a faceplate of the upright assembly, the plurality of gear shafts and central axle all substantially parallel and extending in the same direction.

4. The brake rotor speed reduction system of claim 1, wherein the relative position of each gear shaft with respect to the axle is fixed.

5. The brake rotor speed reduction system of claim 1, wherein the plurality of gear shafts are fixedly coupled to each other through a gear yoke that holds the position of each gear shaft with respect to the plurality of gear shafts fixed as the gear shafts rotate about the axle.

6. The brake rotor speed reduction system of claim 1, wherein the hub bearing is rotatably coupled to the axle.

7. The brake rotor speed reduction system of claim 1, wherein the planetary gear system is contained within an encasement comprising an outer seal bearing coupled to the hub bearing, the rotor body coupled to an inner bearing plate, and the inner bearing plate coupled to an inner sealing plate.

8. The brake rotor speed reduction system of claim 1, wherein at least one of the solar gear and each of the plurality of planet gears is held in alignment within the planetary gear system by at least one positioning bearing.

9. A brake rotor speed reduction system, comprising:
a brake rotor having a rotor body comprising a ring gear of a planetary gear system;
a central axle;
a wheel plate coupled to a hub bearing comprising a solar gear of the planetary gear system, the hub bearing fixedly coupled to the axle; and
a plurality of planet gears, each planet gear rotatably coupled to a different gear shaft of a plurality of gear shafts and engaged with both the ring gear and the solar gear;
wherein the plurality of gear shafts are fixedly coupled to each other through a gear yoke that holds the position of each gear shaft with respect to the plurality of gear shafts fixed as the gear shafts rotate about the axle; and
wherein rotation of the solar gear coupled to the wheel plate in a first direction drives the rotation of each planet gear about the gear shaft to which it is coupled in a second direction opposite the first direction which in turn drives the ring gear of the rotor body to rotate in the first direction and drives the brake rotor to rotate slower than the wheel plate.

10. The brake rotor speed reduction system of claim 9, wherein the planetary gear system is contained within an encasement comprising an outer seal bearing coupled to the hub bearing, the rotor body coupled to an inner bearing plate, and the inner bearing plate coupled to an inner sealing plate.

11. The brake rotor speed reduction system of claim 9, wherein the plurality of planet gears comprises two planet gears positioned opposite each other with the axle in between.

12. The brake rotor speed reduction system of claim 9, wherein the brake rotor further comprises a floating rotor facing portion coupled to the periphery of the rotor body.

13. The brake rotor speed reduction system of claim 9, wherein the planetary gear system is coplanar with the brake rotor body.

14. The brake rotor speed reduction system of claim 9, wherein the brake rotor is slotted.

15. The brake rotor speed reduction system of claim 9, wherein the brake rotor is ventilated.

16. A brake rotor speed reduction system, comprising:
a brake rotor having a rotor body comprising a ring gear of a planetary gear system;
an upright assembly comprising a central axle and a plurality of gear shafts extending outward from a faceplate, the plurality of gear shafts and central axle all substantially parallel and extending in the same direction;
a wheel plate coupled to a hub bearing comprising a solar gear of the planetary gear system, the hub bearing rotatably coupled to the axle; and
a plurality of planet gears, each planet gear rotatably coupled to a different gear shaft of a plurality of gear shafts and engaged with both the ring gear and the solar gear;
wherein rotation of the solar gear coupled to the wheel plate in a first direction drives the rotation of each planet gear about the gear shaft to which it is coupled in a second direction opposite the first direction which in turn drives the ring gear of the rotor body to rotate in the first direction and drives the brake rotor to rotate slower than the wheel plate.

17. The brake rotor speed reduction system of claim 16, wherein the planetary gear system is contained within an encasement comprising an outer seal bearing coupled to the hub bearing, the rotor body coupled to an inner bearing plate, and the inner bearing plate coupled to an inner sealing plate.

18. The brake rotor speed reduction system of claim 16, wherein the plurality of planet gears comprises two planet gears positioned opposite each other with the axle in between.

19. The brake rotor speed reduction system of claim 16, wherein the brake rotor further comprises a floating rotor facing portion coupled to the periphery of the rotor body.

20. The brake rotor speed reduction system of claim 16, wherein the brake rotor is at least one of slotted and ventilated.
